(19) United States
(12) Patent Application Publication
(10) Pub. No.: US 2014/0229262 A1
(43) Pub. Date: Aug. 14, 2014

(54) SYSTEM AND METHOD FOR PROMOTIONAL ITEM DISTRIBUTION AND REDEMPTION TRACKING

(71) Applicants: Douglas H. Kato, Rancho Palos Verdes, CA (US); Kikuo Nishi, Irvine, CA (US); Kenneth Ong, La Mirada, CA (US); Stacy A. Haitsuka, Las Vegas, NV (US); Brian Roesler, Lake Oswego, OR (US)

(72) Inventors: Douglas H. Kato, Rancho Palos Verdes, CA (US); Kikuo Nishi, Irvine, CA (US); Kenneth Ong, La Mirada, CA (US); Stacy A. Haitsuka, Las Vegas, NV (US); Brian Roesler, Lake Oswego, OR (US)

(73) Assignee: QMANIA, INC., Long Beach, CA (US)

(21) Appl. No.: 13/360,592

(22) Filed: Jan. 27, 2012

(51) Int. Cl. G06Q 30/02

(52) U.S. Cl. 705/14.26

(57) ABSTRACT

A promotional system is provided that receives a promotional item and promotional campaign information comprising rules for distributing and tracking a plurality of offers including at least one promotional item, stores the promotional item and promotional campaign information comprising rules for distributing and tracking the plurality of offers, and obtains one promotional item and provides one offer comprising one code (or one validation element) with one promotional item and transmits the offer

The design further includes obtaining the validation element or code provided from a user or user computing device at a point of sale, triggering a redemption indication for the promotional item. The design also includes receiving the redemption indication for the promotional item and limiting further use of the promotional item according to established rules maintained at the computing device.

### BACKGROUND OF THE INVENTION

1. Field of the Invention

The present invention relates generally to the art of mobile devices and use of promotional materials, such as coupons, with such devices, and more specifically to the distribution, tracking, and redemption of promotional materials using mobile devices.

2. Description of the Related Art

Current merchants are very interested in distributing promotional offers and related information to interested users. Many of today's users employ mobile devices, such as smartphones, and retailers and merchants wish to provide such users with promotional materials.

Traditional paper coupons are well known. Traditional coupons are distributed on paper to users, and users can take them or cut them out of magazines or newspapers and redeem them at a merchant and obtain discounts or promotions—money off, 2 for 1, a free gift, etc. Current retailers and merchants are interested in building on this model which the public has come to know and accept.

A paper coupon may be provided with a barcode or indication which can allow for scanning using a barcode reader. Many of these codes are simply scanned to provide the benefit to the user, for example in a checkout line at a grocery store, obtaining twenty cents off on an item purchased. Such barcodes are not typically employed for tracking purposes, but such use has increased in recent years. Further, it is noted that in printing such coupons, it is very expensive to provide them with dynamic individualized barcodes or information in printed media, so they are typically all provided with uniform identifying information. It can then be difficult or impossible for the merchant or retailer holding the coupon to know where the purchaser obtained the coupon.

Paper coupons are also problematic in that they create paper clutter, and no record is generally kept such that when redeemed and lost in transit, the store has no proof they were sent. Further, certain points of sale have been known to seek compensation by submitting coupons for sales that were not actually made.

Paper coupons are typically printed using color and are printed using fairly high quality printing techniques. As a result, copying using commonly available copying devices is typically unsuccessful, as a copied coupon can in many cases be easily identified. Thus while multiple copies of a coupon may be distributed in varying forms, persons have difficulty using a coupon more than once or providing a coupon to a friend.

This is not true in the digital environment. Smartphones are currently being used to display items such as promotions, airline ticket information, etc. which can be placed in front of a scanner. The scanner can be used to determine the image displayed on the smartphone, transmitting the information displayed on the smartphone to a computing device that acts based on the information obtained. Because there is no degradation of an electronic version of promotional materials, a person obtaining an electronic coupon may reuse the electronic coupon or may transmit the electronic coupon to a friend, or may use the electronic coupon for a friend after he has used it himself.

Further, as with paper coupons, the problem with electronic promotional materials or coupons is that they can be difficult or impossible to track. Merchants and retailers are very interested in tracking the use of promotional materials, particularly attributes such as where the user obtained the promotional materials, when she obtained them, when she used them, and possibly her interests as they relate to the merchant or item purchased. Such information is typically unavailable in today's electronic environment, particularly in view of the fact that certain points of sale only offer redemption using special point of sale (POS) hardware and/or software.

Other problems exist with digital promotional items or coupons. Since no actual physical item is placed in a cash register or other device at the point of redemption, unscrupulous point of sale representatives can input a known mobile discount code at the point of sale, effectively pocketing the discount amount. For example, a parking lot attendant may input that he received fifty $1 off mobile coupons and pockets the $50. Since the mobile coupon is only seen by the parking attendant, there can be no tracking of the physical discount. Another example is a waiter who is paid in cash, but enters at the register that she was presented with a 20 per cent off mobile coupon when in fact she was not, and deposits 80 per cent of the check and keeps the other 20 per cent. Both of these situations are undesirable.

Based on the foregoing, it would be advantageous to provide a process for the efficient distribution and tracking of promotional offers and advertising materials to new media devices that overcomes the drawbacks present in previously known designs.

### SUMMARY OF THE INVENTION

According to one aspect of the present design, there is provided a promotional system that receives a promotional item and promotional campaign information comprising rules for distributing and tracking a plurality of offers including at least one promotional item, stores the promotional item and promotional campaign information comprising rules for distributing and tracking the plurality of offers, and obtains one promotional item and provides one offer comprising one code (or one validation element) with one promotional item and transmits the offer. The design further includes obtaining the validation element or code provided from a user or user computing device at a point of sale, triggering a redemption indication for the promotional item. The design also includes receiving the redemption indication for the promotional item and limiting further use of the promotional item according to established rules maintained at the computing device.

These and other advantages of the present invention will become apparent to those skilled in the art from the following detailed description of the invention and the accompanying drawings.

### BRIEF DESCRIPTION OF THE DRAWINGS

The present invention is illustrated by way of example, and not by way of limitation, in the figures of the accompanying drawings in which:

FIG. 1 illustrates the general components of the present system 100;

FIG. 2 is a general flowchart of operation of the current design; and

FIG. 3 shows an alternative representation of the present design.

### DETAILED DESCRIPTION OF THE INVENTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

The present design enables a user or customer to obtain a coupon or other promotional material on a smartphone or other mobile device and for the user to redeem the coupon or promotional item at a retailer and to track the redemption of the coupon. Such managing and tracking of the promotional item enables the retailer to limit the number of times the promotion can be employed, such as only once. Expiration date for a coupon or promotional item may also be enforced.

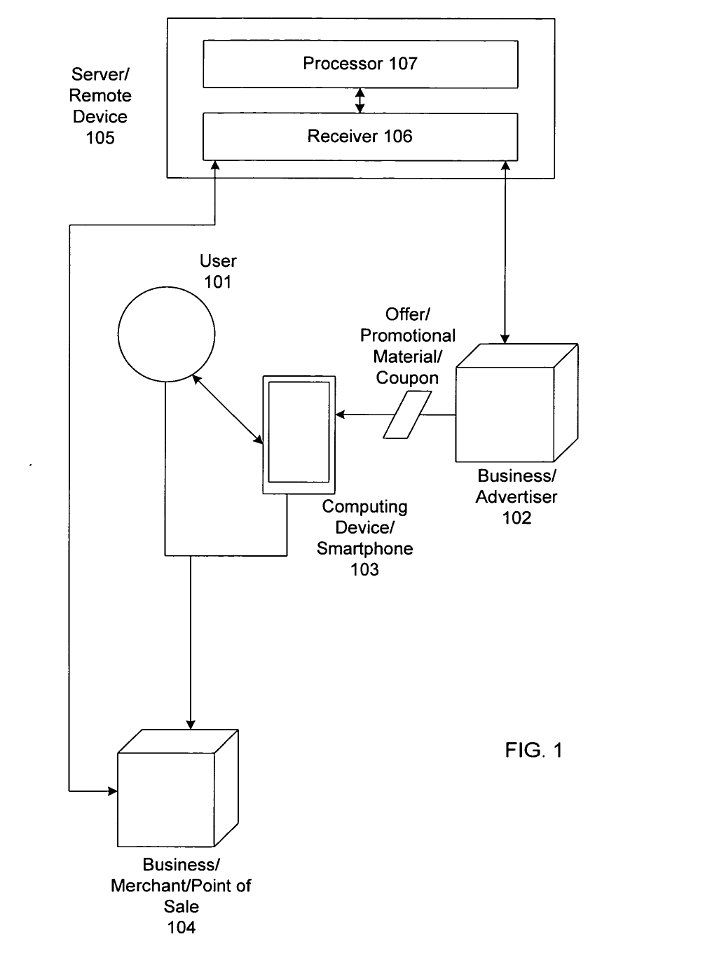

FIG. 1 illustrates the general components of the present system 100. A user or customer 101 may employ a smartphone or other appropriate computing device 103. An entity 102 such as a business (retailer, merchant, manufacturer, advertiser, etc.) may transmit a promotional item to user or customer 101 via his computing device 103. The customer 101 may then bring his computing device 103 to a place of business or point of sale 104 and may present the promotional item using an application or via sms, instant message, email, or web browser. The promotional item may come in various forms, and either the user or a representative at the place of business 104 may push a physical or virtual button, may enter a code into an application, may perform some type of physical action such as a swipe of the device 103, may reply or otherwise transmit the promotional item using sms or another form of instant messaging, or may employ a voice command to obtain the promotional material. The promotional material may also be obtained using a scanner, such as a barcode scanner, QR code scanner, or other code or graphic scanner. The merchant or a third party may also track the user based on information available from her smartphone, such as GPS location, or the smartphone may communicate with the merchant or retailer place of business 104 using, for example, Bluetooth communications, Wi-Fi, RFID, or other appropriate communication techniques.

The promotional offer might be made available to the consumer/user based on GPS (Geographical Positioning System) determined location. Also, the redemption might be triggered based on GPS location, or promotional material could be obtained/provided based on GPS location, such as when the user has her device at a retailer or point of sale location.

Various codes may be provided with the promotional item and may be conveyed to the merchant or retailer place of business 104. A unique identification code may be included, or other codes indicating how the promotional information may be used either by the user 101 or by the place of business 104, expiration date codes, processing information such as the location or URL of a server that should be contacted when or after the promotional item is redeemed, number of uses available, and so forth. Such information may be applied in a standard format or a specific format desired by the retailer, merchant, or some third party.

The codes provided with the promotional material are available to the merchant or retailer at the place of business 104, and all information or only select information associated with the promotional material may be obtained by the place of business 104 from the computing device 103. The conveyance of information from the computing device 103 to the place of business 104, or vice versa, is considered a redemption trigger.

Codes and information may be provided in various ways in the general representation illustrated in FIG. 1. As an example, a code may be provided with the promotional material or offer from an advertiser to the user's device. A different code, such as an unlock code, may be provided from a third party or remote device to the point of sale when a proper identification has been made, i.e. an “unlock” code may be provided to the point of sale or merchant 104 that unlocks the offer or benefit to the user. Such an unlock code may be provided when a visual verification is provided, based on rules and conditions established by the advertiser or campaign initiating entity.

In one embodiment, upon triggering the redemption or causing the redemption trigger to be valid, the smartphone or computing device 103 may record the redemption trigger. The smartphone or computing device 103 may then transmit the redemption trigger or a code or other information to a server or other device 105 either immediately or at a later time. While shown as two separate components in FIG. 1, it is to be understood that server or other device 105 may be associated with or housed at entity or business 102. The server or other device 105 receives the data at receiver 106 and processes the data at processor 107, and may maintain relevant information on a storage device (not shown). Alternatively, the information may be maintained on the smartphone or computing device 103 and processed on the smartphone or computing device using a processor (not shown) and processed information may be transmitted to the server or other device 105 at a later time.

The server or remote device 105 may be controlled and/or operated by a merchant or another entity, and may include both an ability to establish the promotional offer (providing codes, distribution, campaigns, and other information prior to redemption trigger) as well as functionality after the redemption has been triggered.

Before the promotional offer has been provided to users, the server or remote device 105 employs an interface module wherein personnel may establish the particular redemption campaign, including establishing identification codes (unique codes or common codes) for the promotional items, redemption locations, amount of times such promotional material may be provided, expiration dates, and so forth.

One aspect of the present design is the ability for the retailer or merchant place of business 104 to obtain a code, either by being shown a code on the user's computing device 103, which may be a complex code or a simple code such as a word or three digit number, or by receiving the code via electronic transmission (sms or text, Bluetooth, etc.). A representative at the retailer or merchant place of business 104 (employee, etc.) may obtain the code, either by viewing the code or by receiving in some manner via transmission from the user's device 103. The representative may enter the code on a device, such as a device maintained at the retailer or merchant place of business 104 configured to contact the server or remote device 105. The code may be anything available that will verify the user and/or the user's possession of the promotion, including voice recognition or facial recognition information, verification of credit card information, a number or code identifying the user and/or her phone or computing device, or other known verification methods.

Another aspect of the present design is the ability for the retailer or merchant place of business 104 to obtain a code from remote server device 105, which may be a complex code or a simple code such as a word or three digit number, or by receiving the code via electronic transmission (sms or text, Bluetooth, etc.). A representative at the retailer or merchant place of business 104 (employee, etc.) may obtain the code, either by viewing the code or by receiving in some manner via transmission from the remote server device 105. The representative of the business 104 may then enter the code on a user device 103, such as a smartphone, to trigger redemption. The code may be anything available that will verify the business 104 and/or the businesses' acceptance of the promotion, including voice recognition or facial recognition information, verification of credit card information, a number or code identifying the business 104.

Once the communication of the promotional item has occurred, namely providing the promotional item or coupon in any manner from the user's smartphone or computing device 103 to a computing device at the retailer or merchant place of business 104, either electronically or via a point of sale representative, the information is transmitted from the computing device at the retailer or merchant place of business 104 to the server or remote device 105 and processing at the server or remote device 105 occurs. Processing may include approval of a benefit or discount being conveyed back to the computing device at the retailer or merchant place of business 104 and/or to the user's smartphone or computing device 103, and may include additional information.

The transmission of information from either the user's computing device 103 or the computing device at or associated with the retailer or merchant place of business enables an entity, such as the entity issuing the promotional item, to track which promotional item was redeemed, at what time, where, and any other pertinent information available. The code provided with the promotional item may provide certain information, as may GPS tracking if available for the user's computing device 103. Thus the server or remote device 105 may not only obtain information based on the redemption trigger (i.e. transmission from the user's computing device 103 or the merchant or retailer place of business 104), but also from other channels, such as a global positioning (GPS) tracking channel.

Certain information can be collected if available and if desired, depending on circumstances. For a user who has elected to offer such information, information such as age, sex, location, frequency of coupon use, web site visitation information, user preferences, and so forth. Those users not wishing to provide such information would not provide such information to promotional material distributing entities.

According to the present design, the entity providing the promotional material can control how often and under what circumstances a coupon or promotional item can be redeemed, and even when and under what circumstances a promotional item may be redeemed. For example, the issuing entity may mandate that a half off coupon may only be redeemed once per week per customer, or the promotion may not be available until one week after the customer or user receives the promotion. Virtually any rule or condition can be imposed.

The user computing device 103 may be configured to provide the user with a user device application, such as a coupon cart or shopping cart, that may be configured to collect all promotional materials or collect promotional materials and products or services, such as 50 per cent off computer RAM plus the computer RAM offer. The user may be offered the information or configuration when she is at a specific location, such as a retail store, and the promotions may only be offered to her when she is in the store, when she is in the store or after she has left for the remainder of the day, or according to any other condition provided. The user device so configured may also provide the user with a reactivation, such as if the offer is good once per day, the user device may be configured to reset the offer each day. Active promotional items or information may be provided based on user location as entered by the user or based on positioning, such as GPS. Coupon or offers are searchable by keywords, location, business, and so forth, in that the user enters a string of characters or information and the computing device performs a search for the desired information. The device may also be configured to provide the user with expired promotional information or used promotions, such that the user can track promotions and possibly revisit web sites or retailers to obtain the information. Coupon/promotion reactivation can also be triggered from server or remote device 105 directly by transmission to user device 103.

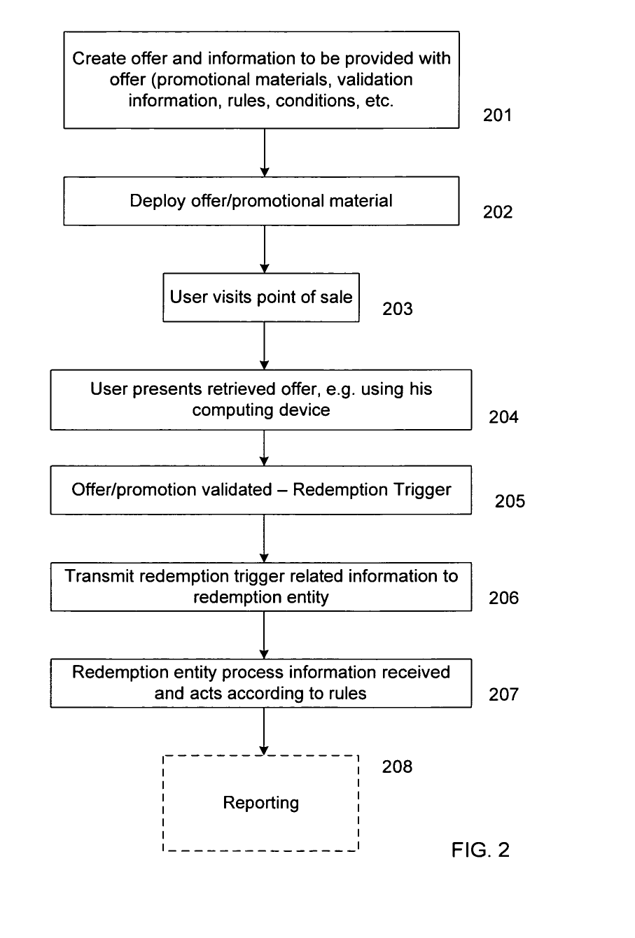

FIG. 2 illustrates a general overall flowchart for the system. At point 201, an entity creates an offer, including graphics or relevant information, in addition to information to be provided with the offer, such as codes, etc. The offer provided also includes any redemption information, including rules or conditions such as the user does not receive the promotion or benefit until the specific code has been provided, or the user has been validated, and so forth. Point 202 represents deployment of the promotional material, such as by placing the promotion on a web site or sites, sending the information upon request, sending via text message to those signed up, or any other method of conveying the offer, including providing a paper coupon. At point 203, the user visits a location, such as a merchant or retailer location, and may seek to satisfy the conditions of the offer, such as buying the item, purchasing the service, or simply presenting himself to a representative. At point 204, the user presents the offer using his computing device.

Point 205 validates the offer, either by the user or a representative at the point of sale electronically seeking approval or the merchant or retailer verifying the user or offer. Point 205 represents the redemption trigger. Information is transmitted to an entity, such as an offsite server controlled by a retailer, at point 206, either by the user or the redeeming merchant or point of sale entity. The information is processed at point 207, and point 208 represents optional reporting, such as reporting the number of offers redeemed, and so forth. Not shown, but what may be going on in parallel to the actions of FIG. 2, is the transmission of updated information (new offers, expiration of offers, etc.) as well as the collection of information as appropriate and as provided by the user's computing device or smartphone.

Thus according to the present design there is provided an apparatus and method for distributing and redeeming promotional materials. The design includes receiving, at a computing device, a promotional item and promotional campaign information comprising rules for distributing and tracking a plurality of offers including at least one promotional item, storing the promotional item and promotional campaign information comprising rules for distributing and tracking the plurality of offers at the computing device, and obtaining at least one promotional item and providing at least one offer comprising at least one code or at least one validation element with at least one promotional item and transmit the offer to a user. A validation element is anything that may be used to validate the promotional item and allow the user to obtain a benefit, including as noted, facial recognition, visual recognition by a point of sale representative, voice recognition, a code and/or set of codes, a password, a secret word, a redemption trigger word, etc.

The design further includes obtaining the validation element or code provided from a user or user computing device at a point of sale, thereby triggering a redemption indication for the promotional item associated with the validation element or code. The design also includes receiving the redemption indication for the promotional item and limiting further use of the promotional item according to established rules maintained at the computing device. The user presenting an indication available on his computing device at the point of sale is sufficient to cause triggering of the redemption indication. The merchant may also trigger redemption by providing validation on the user device.

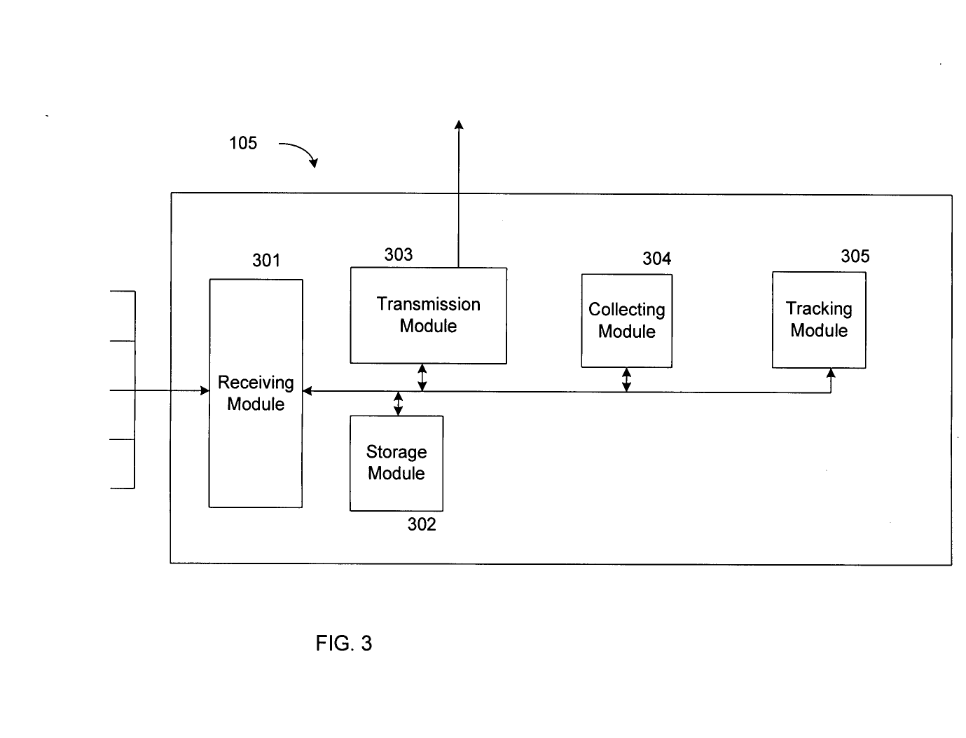

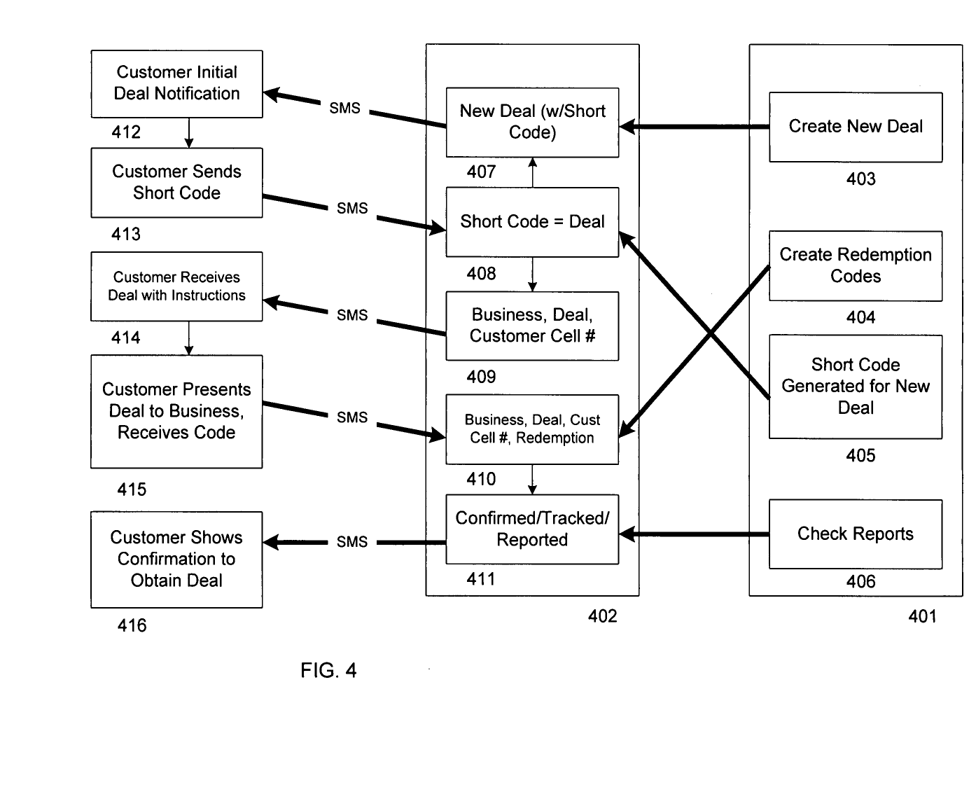

FIG. 3 illustrates an alternate representation of a server or device 105 in accordance with the present design. From FIG. 3, receiving module 301 receives a promotional item and promotional campaign information from a desired or approved source. Rules may also be provided via receiving module 301. Storage module 302 may be provided to store information provided by the receiving module 101 and any other components in the design. Transmission module 303 obtains promotional items and campaign information (rules, etc.) from the storage module 302, and transmits an offer including promotional material, to a web site, to a user, etc. Collecting module 304 obtains redemption trigger information (codes, verifications, validation elements, time, day, user behavorial data, demographic data, GPS information, etc.) provided at the point of sale and triggers a redemption indication for the promotional item and the validation element. Tracking module 305 receives the redemption indication and limits further use of the promotional item (e.g. invalidating, limiting use on a time basis, etc.)

The code provided by the user device may be provided from the user device or a device at the point of sale to the computing device. The design may include providing an approval to the point of sale after the redemption indication is triggered, as well as invalidating the promotional item once the redemption indication is triggered. Indication of such an invalidation of the promotional item may be transmitted to at least one point of sale computing device.

The promotional material or promotional items described herein may include any type of promotional item, including but not limited to coupons and rebates. With respect to rebates specifically, users may be provided with the ability to reserve the benefit at time of purchase rather than mailing in forms, etc., which can be particularly beneficial when a limited number of rebates are offered.

The present design may be employed together with or in connection with a system for communicating promotional information, including but not limited to the design reflected in U.S. patent application Ser. No. 12/587,147, entitled “System and Method for Communicating Promotional Information,” inventor Douglas H. Kato, filed Oct. 2, 2009, the entirety of which is incorporated herein by reference.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

1. A promotional computing device comprising:
a receiver configured to receive a promotional item and promotional campaign information comprising rules for distributing and tracking a plurality of offers including at least one promotional item;
a storage device configured to store the promotional item and promotional campaign information;
a processing apparatus comprising a transmission module configured to obtain one promotional item from the storage device and provide one offer comprising one code with one promotional item and transmit the offer; and
a collecting module configured to obtain the code provided from a user computing device at a point of sale, thereby triggering a redemption indication for the promotional item associated with the code and transmit the redemption indication to the processing apparatus for confirmation of redemption of the offer without the collecting module providing an indication of approved redemption of the offer;
wherein the processing apparatus further comprises a tracking module configured to receive the redemption indication for the promotional item, transmit an approval or denial of redemption of the offer to the collecting module based on a current status of the offer, and limit further use of the promotional item according to established rules.

2. The promotional computing device of claim 1, wherein the code provided by the user device is provided from the user device to the promotional computing device.

3. The promotional computing device of claim 1, wherein the code provided by the user device is provided from a point of sale device to the promotional computing device.

4. The promotional computing device of claim 1, wherein the collecting module is further configured to provide an approval to the point of sale and/or user device after the redemption indication is triggered.

5. The promotional computing device of claim 1, wherein the tracking module is configured to invalidate the promotional item once the redemption indication is triggered.

6. The promotional computing device of claim 5, wherein the tracking module is further configured to transmit an indication of invalidation of the promotional item to at least one point of sale computing device and/or user computing device.

7. The promotional computing device of claim 1, wherein the promotional material comprises one from a group consisting of a coupon and a rebate.

8. The promotional computing device of claim 1, wherein the user presenting an indication available on his computing device at the point of sale is sufficient to cause triggering of the redemption indication.

9. A method for distributing and redeeming promotional materials, comprising:
receiving, at a computing device, promotional campaign information comprising rules for distributing and tracking a plurality of offers including at least one promotional item;
storing the at least one promotional item and promotional campaign information comprising rules for distributing and tracking the plurality of offers at the computing device;
obtaining one promotional item and providing one offer comprising one code with one promotional item and transmitting the offer;
obtaining one from a group consisting of the code and an action from a user at a point of sale, thereby triggering a redemption indication for the promotional item;
transmitting the redemption indication from the point of sale to the computing device for confirmation of redemption of the offer without the point of sale indicating approved redemption of the offer;
receiving, at the computing device, the redemption indication for the promotional item;
transmitting an approval or denial of redemption of the offer to the collecting module based on a current status of the offer; and
limiting further use of the promotional item according to established rules maintained at the computing device.

10. The method of claim 9, wherein the code is provided from a user device to the computing device.

11. The method of claim 9, wherein the code is provided from a point of sale device to the computing device.

12. The method of claim 9, further comprising providing an approval to the point of sale and/or user device after the redemption indication is triggered.

13. The method of claim 9, further comprising invalidating the promotional item once the redemption indication is triggered.

14. The method of claim 13, further comprising transmitting an indication of invalidation of the promotional item to at least one point of sale and/or user computing device.

15. The method of claim 9, wherein the promotional material comprises one from a group consisting of a coupon and a rebate.

16. The method of claim 9, wherein the user presenting an indication available on his computing device at the point of sale is sufficient to cause triggering of the redemption indication.

17. A promotional computing device comprising:
a receiver configured to receive a promotional item and promotional campaign information comprising rules for distributing and tracking a plurality of offers including at least one promotional item;
a storage device configured to store the promotional item and promotional campaign information;
a processing apparatus comprising a transmission module configured to obtain one promotional item from the storage device and provide one offer comprising one validation element with one promotional item and transmit the offer; and
a collecting module configured to obtain the validation element provided from a user computing device at a point of sale, thereby triggering a redemption indication for the promotional item associated with the validation element and transmit the redemption indication to the processing apparatus for confirmation of redemption of the offer without the collecting module providing an indication of approved redemption of the offer to selectively [[and]] enable the user to obtain a benefit at the point of sale;
wherein the processing apparatus further comprises a tracking module configured to receive the redemption indication for the promotional item, transmit an approval or denial of redemption of the offer to the collecting module based on a current status of the offer, and limit further use of the promotional item according to established rules.

18. The promotional computing device of claim 17, wherein the validation element provided by the user is provided from a user device to the promotional computing device.

19. The promotional computing device of claim 17, wherein the validation element provided by the user is received at a point of sale device and an indication of receipt of the validation element is transmitted from the point of sale device to the promotional computing device.

20. The promotional computing device of claim 17, wherein the user presenting an indication available on his computing device at the point of sale is sufficient to cause triggering of the redemption indication.

21. The promotional computing device of claim 17, wherein the collecting module is further configured to receive redemption information, wherein the redemption information comprises on from a group consisting of:
time of day of a redemption;
geographic location of the redemption;
user behavioral data for the user causing the redemption; and
sales representative data associated with the redemption.

22. A method for distributing an offer to a customer and enabling the customer to redeem the offer at a point of sale, comprising:
transmitting from a computing device one offer comprising a redemption indication to a customer device;
obtaining the redemption indication transmitted to the customer device at the point of sale, thereby triggering a redemption indication approval request for the promotional item associated with the redemption indication;
transmitting the redemption indication approval request from the point of sale to the computing device;
transmitting an approval from the computing device to the point of sale when the one offer is approved by the computing device as valid; and
limiting further use of the promotional item according to established rules when the one offer is approved and when the one offer is disallowed maintained.

23. The method of claim 22, wherein said transmitting from the computing device occurs via SMS (short messaging service).
